(19) United States
(12) Patent Application Publication
(10) Pub. No.: US 2026/0282049 A1
(43) Pub. Date: Sep. 17, 2026

(54) MESH WIRELESS LOCAL AREA NETWORK DISCOVERY WITH MULTI-LINK OPERATION

(71) Applicant: HUAWEI TECHNOLOGIES CO., LTD., Shenzhen (CN)

(72) Inventors: Michael Montemurro, Ottawa (CA); Stephen McCann, Ottawa (CA); Arik Klein, Hod Hasharon (IL)

(73) Assignee: HUAWEI TECHNOLOGIES CO., LTD., Shenzhen (CN)

(21) Appl. No.: 19/672,322

(22) Filed: May 8, 2026

Related U.S. Application Data
(63) Continuation of application No. PCT/EP2023/081344, filed on Nov. 9, 2023.

(51) Int. Cl. H04W 72/25; H04W 84/12; H04W 84/18; H04W 88/06; H04W 88/10

(52) U.S. Cl. CPC H04W 72/25; H04W 84/12; H04W 84/18; H04W 88/06; H04W 88/10

(57) ABSTRACT

A method of configuring a mesh multi-link device (MLD) operating in a mesh network using multi-link operation (MLO), wherein the mesh network including a plurality of mesh stations (STAs) and mesh MLDs, wherein the MLD communicates over multiple wireless local area network (WLAN) radio links between one or more access point (AP) MLDs and one or more non-AP MLDs, wherein each MLD has one or more affiliated STAs, and wherein each affiliated STA operates on a different link designated for mesh operation. The method comprising receiving multi-link operation mesh basic service set (MLO MBSS) information indicating MLO MBSS capability and/or operational parameters, and advertising the mesh capability of the MLD using a mesh multi-link element (MLE) included in the MLO MBSS information.

### CROSS-REFERENCE TO RELATED APPLICATIONS

This application is a continuation of International Application No. PCT/EP2023/081344, filed on Nov. 9, 2023, the disclosure of which is hereby incorporated by reference in its entirety.

### TECHNICAL FIELD

The present disclosure generally relates to methods and systems in the field of WLAN Mesh operations.

### BACKGROUND OF THE INVENTION

A Basic Service Set, BSS, is an IEEE 802.11 definition of a set of stations that can communicate with each other either directly, e.g. a mesh network, or through an Access Point, AP, i.e. an infrastructure BSS. It is the basic network building block of an IEEE 802.11 WLAN.

When a mesh STA, which does not support the functionalities of an Infrastructure BSS, initiates connectivity for a mesh basic service set, MBSS, in other words a mesh network, it attempts to discover other mesh STAs and it begins transmitting beacon frames advertising the MBSS. Other mesh STAs then use traditional discovery mechanisms in IEEE 802.11, such as
Passive scan listens for Beacon or unsolicited Probe Response frames;
Active scan transmits Probe Request frames/receive Probe Response frames.

IEEE 802.11 defines communications requirements for STAs that operate in a mesh network. Mesh STAs discover and peer with each other to form mesh links. Data can be routed between peer mesh STAs through a series of hops through other STAs operating in a mesh network.

In a typical Mesh Architecture that may be implemented according to IEEE 802.11, information is exchanged between the mesh and external infrastructure, e.g. a BSS 1 at a STA 1, or a LAN at a STA 4. Mesh peering links are associated links, e.g. with established security between the Mesh STAs. These links are typically within the same WLAN frequency band, e.g. 2.4 GHz.

IEEE 802.11be has introduced a multi-link device, MLD. MLDs communicate over multiple WLAN radio links between an AP MLD and non-AP MLD. MLDs allow traffic exchange on multiple links providing a performance gain of using multiple channels.

In particular, each AP MLD may have one or more affiliated APs, where each affiliated AP is operating on a different link. Similarly, each non-AP MLD has one or more affiliated non-AP STAs, where each affiliated non-AP STA is operating on a different link.

IEEE 802.11be also introduces dynamic link transitions, where traffic can be moved from one link to another, as the non-AP STA affiliated with the non-AP MLD, operating on one of the links, can be in active mode or in power save mode.

An IEEE 802.11 reduced neighbor report, RNR, element is included in Beacon and Probe Response frames and is defined as contain channel and other information about neighbor APs or APs affiliated with the AP MLD as the AP that transmits the Beacon and Probe Response frames.

A Multi-Link Element, MLE, includes information corresponding to other links of the MLD that the AP or non-AP STA, that transmit the frame in which the MLE is included, are affiliated with.

### SUMMARY

Currently, very little work has been done in IEEE 802.11be and subsequently in IEEE 802.11bn to support multi-link operation, MLO, with mesh networking. There are multiple aspects of mesh features that need to be updated in order to take care of MLO.

The present disclosure attempts to mitigate this situation. The present disclosure relates to advertisement and discovery aspects of an MLO MBSS.

The present disclosure is defined by the scope of the independent claims. The dependent claims provide advantageous embodiments of the present disclosure.

The present disclosure provides:

A first aspect of a method of configuring a mesh multi-link device, MLD, the MLD operating in a mesh network using multi-link operation, MLO, the mesh network including a plurality of mesh STAs and mesh MLDs, the MLD communicating over multiple WLAN radio links between one or more AP MLDs and one or more non-AP MLDs, wherein each MLD has one or more affiliated STAs, where each affiliated STA operates on a different link designated for mesh operation; the method comprising: receiving multi-link operation mesh basic service set, MLO MBSS, information indicating MLO MBSS capability and/or operational parameters; wherein a specific mesh multi-link element, MLE, is included in the MLO MBSS information, advertising the mesh capability of the MLD using the specific MLE.

Thus, according to the method of the first aspect, it is established a protocol of how an MLD discovers a peer mesh MLD.

According to an implementation of the method of the first aspect, receiving multi-link operation mesh basic service set, MLO MBSS, information indicating MLO MBSS capability may comprise: receiving a beacon frame or unsolicited Probe Response frame; or receiving a Probe Response frame as a response to a solicited Probe Request frame; or receiving a multi-link Probe Response as a response to a solicited multi-link Probe Request.

According to an implementation of the method of the first aspect, the method may further comprise: updating a reduced neighbor report, RNR, element and advertising the updated RNR element in a Beacon frame and Probe Response frame together with advertising the specific MLE; and updating mesh operation on one or more STAs affiliated with the MLD allowing the MLD to advertise and discover various MBSSes on the links designated for mesh operation.

Thus, according to these implementations, the mesh MLD should advertise a new mesh variant multi-link element, MLE, together with an update of the existing reduced neighbor report, RNR, element in Beacon and Probe Response frames.

According to an implementation of the method of the first aspect, the method may further comprise: configuring the specific MLE for advertising mesh capability, wherein configuring the specific MLE may comprise: extending a field of the MLE indicating information common to all links, Common Info field, by an element for advertising mesh services, Mesh Configuration Element; updating a field of the MLE indicating control of multi-link, Multi-Link Control field, by extending a subfield of the Multi-Link Control subfield having a bitmap, Presence Bitmap subfield, by an indicator, Mesh Configuration Element Present indicator, indicating that the Mesh Configuration Element is present in the Common Info field, and further extending the Presence Bitmap subfield by an indicator indicating whether all of the links have mesh capability.

Thus, providing the updated MLE allows the Mesh MLD to advertise its MLO MBSS capability in the updated MLE.

According to an implementation of the method of the first aspect, the method may further comprise: configuring the specific MLE for advertising mesh capability, wherein configuring the specific MLE may comprise: in a subfield of the MLE indicating control of multi-link, Multi-Link Control subfield, assigning a new type value in a subfield of the Multi-Link Control subfield, Type subfield, the new type value indicating that the specific MLE is used for mesh operation.

Thus, providing the new type of MLE allows the Mesh MLD to advertise its MLO MBSS capability using the new Mesh MLE.

According to an implementation of the method of the first aspect, the method may further comprise: updating the RNR element by including a subfield, Mesh Capable subfield, indicating links being available for mesh operation, wherein the value of the Mesh Capable subfield being equal to 1 indicates the link is available for mesh operation.

According to an implementation of the method of the first aspect, the method may further comprise: discovering mesh MLO using a mesh multi-link probe request and response, wherein the discovering may comprise: receiving information details of the peer mesh MLD prior to peering with another mesh MLD, wherein the information details received from the mesh MLD include the specific MLE having mesh capability, the specific MLE including a field for link information, Link Info field, corresponding to all other affiliated STAs operating in the Mesh BSS or about specific requested affiliated STAs operating in the Mesh BSS.

Thus, mesh multi-link probe request and response may be used to discover the MLO MBSS capability and parameters within the Mesh MLE of a peer Mesh MLD.

According to an implementation of the method of the first aspect, in the method the Link Info field may indicate which links support the mesh operation and the corresponding mesh parameters.

According to an implementation of the method of the first aspect, in the method the mesh multi-link probe request may include the Link Info field indicating a specific one or more affiliated STAs, from which a response is required.

According to an implementation of the method of the first aspect, the method may further comprise: in case all links of the MLD are mesh capable, the Common Info field of the updated MLE is used to include the Mesh Configuration Element and indicating that all links support the mesh operation, wherein mesh information included in the Mesh Configuration Element applies to all links; else in case only some of the links of the MLD are mesh capable, information common to all mesh capable links of the MLD is included in the Common Info field of the MLD, whereas link specific information is included in a subfield of the Link Info field of the MLE indicating STA profiles, Per-STA Profile sub element, wherein the link specific information is obtained by receiving a response to a mesh multi-link probe request from a peer MLD having mesh capability.

According to an implementation of the method of the first aspect, the method may further comprise: in case only some of the links of the MLD are mesh capable, a subfield of the Per-STA Profile sub element, indicating control of STAs, STA Control subfield, is updated to include a subfield indicating mesh parameters in a Mesh Capable STA Info field, and a subfield indicating mesh parameters in a Mesh Capable STA Profile field.

According to an implementation of the method of the first aspect, the method may further comprise: in case the value of the Mesh Capable Common subfield is equal to 0, the value of the Mesh Capable STA Info subfield is equal to 1, indicating that the link is mesh capable and all of the mesh configuration information specific to the link is included in the STA Info subfield of the updated MLE.

Thus, the above allows for legacy mesh configuration information in the Mesh Configuration Element to be re-mapped with an MLD architecture, providing both common MLD mesh specific information and MLD mesh link specific information.

According to an implementation of the method of the first aspect, the method may further comprise: in case only some of the links of the MLD are mesh capable, a subfield of the updated MLE indicating STA information, STA Info subfield, includes a TBTT Adjusting subfield and/or a Mesh Power Save Level subfield.

According to an implementation of the method of the first aspect, in the method the TBTT Adjusting subfield and/or the Mesh Power Save Level subfield are to be removed from the Mesh Configuration Element of the Common subfield.

According to an implementation of the method of the first aspect, the method may further comprise: in case a mesh profile of each STA affiliated with the respective mesh STA is the same, the method further comprises: advertising the mesh capability of the MLD having mesh capability by updating a predefined Mesh Configuration Element.

According to an implementation of the method of the first aspect, the method may further comprise: the predefined Mesh Configuration Element is updated by including a subfield for mesh capability extension, Mesh Capability Extension subfield, and the Mesh Configuration Element includes a subfield indicating mesh capability, Mesh Capability subfield, wherein the last bit of the Mesh Capability subfield indicates whether the Mesh Configuration Element is updated by the Mesh Capability Extension subfield.

Thus, this allows a legacy Mesh Configuration Element to be updated to advertise MLO MBSS capability.

The present disclosure further provides a second aspect of a mesh multi-link device, MLD, the MLD being configured to: operate in a mesh network using multi-link operation, MLO, the mesh network including a plurality of mesh STAs and mesh MLDs, communicate over multiple WLAN radio links between one or more AP MLDs and one or more non-AP MLDs, wherein each MLD has one or more affiliated STAs, where each affiliated STA is configured to operate on a different link designated for mesh operation; receive multi-link operation mesh basic service set, MLO MBSS, information indicating MLO MBSS capability and/or operational parameters; wherein a specific mesh multi-link element, MLE, is included in the MLO MBSS information, advertising the mesh capability of the MLD using the specific MLE.

According to an implementation of the device of the second aspect, the device may further comprise: the MLD being configured to receive multi-link operation mesh basic service set, MLO MBSS, information indicating MLO MBSS capability that further comprises the MLD being configured to:
receive a beacon frame or unsolicited Probe Response frame; or receive a Probe Response frame as a response to a solicited Probe Request frame; or receive a multi-link Probe Response as a response to a solicited multi-link Probe Request.

According to an implementation of the device of the second aspect, the device may further comprise: the MLD being configured to: update a reduced neighbor report, RNR, element and advertise the updated RNR element in a Beacon frame and Probe Response frame together with the specific MLE; and update mesh operation on one or more STAs affiliated with the MLD allowing the MLD to advertise and discover various MBSSes on the links designated for mesh operation.

According to an implementation of the device of the second aspect, the device may further comprise: the MLD being further configured to: configure the specific MLE for advertising mesh capability, wherein configuring the specific MLE comprises the MLD being configured to: extend a field of the MLE indicating information common to all links, Common Info field, by an element for advertising mesh services, Mesh Configuration Element; update a field of the MLE indicating control of multi-link, Multi-Link Control field, by extending a subfield of the Multi-Link Control subfield having a bitmap, Presence Bitmap subfield, by an indicator, Mesh Configuration Element Present indicator, indicating that the Mesh Configuration Element is present in the Common Info field, and further extending the Presence Bitmap subfield by an indicator indicating whether all of the links have mesh capability.

According to an implementation of the device of the second aspect, the device may further comprise: the MLD being further adapted to: configure the specific MLE for advertising mesh capability, wherein configuring the specific MLE comprises: in a subfield of the MLE indicating control of multi-link, Multi-Link Control subfield, assigning a new type value in a subfield of the Multi-Link Control subfield, Type subfield, the new type value indicating that the specific MLE is used for mesh operation.

According to an implementation of the device of the second aspect, the device may further comprise: the MLD being configured to update the RNR element by including a subfield, Mesh Capable subfield, indicating links being available for mesh operation, wherein the value of the Mesh Capable subfield being equal to 1 indicates the link is available for mesh operation.

According to an implementation of the device of the second aspect, the device may further comprise: the MLD being further configured to: discover mesh MLO using a mesh multi-link probe request and response, wherein the discovering comprises: receiving information details of the peer mesh MLD prior to peering with another mesh MLD, wherein the information details received from the mesh MLD include the specific MLE having mesh capability, the specific MLE including a field for link information, Link Info field, about all other affiliated STAs operating in the Mesh BSS or about specific requested affiliated STAs operating in the Mesh BSS.

According to an implementation of the device of the second aspect, the device may further comprise: the Link Info field that indicates which links support the mesh operation and the corresponding mesh parameters.

According to an implementation of the device of the second aspect, the device may further comprise: the mesh multi-link probe request includes the Link Info field indicating the specific one or more affiliated STAs from which a response is required.

According to an implementation of the device of the second aspect, the device may further comprise: in case all links of the MLD are mesh capable, the Common Info field of the updated MLE is used to include the Mesh Configuration Element and indicating that all links support the mesh operation, wherein mesh information included in the Mesh Configuration Element applies to all links; else in case only some of the links of the MLD are mesh capable, the information common to all mesh capable links of the MLD is included in the Common Info field of the MLD, whereas link specific information is included in a subfield of the Link Info field of the MLE indicating STA profiles, Per-STA Profile sub element, wherein the link specific information is obtained by receiving a response to a mesh multi-link probe request from a peer MLD having mesh capability.

According to an implementation of the device of the second aspect, the device may further comprise: in case only some of the links of the MLD are mesh capable, a subfield of the Per-STA Profile sub element, indicating control of STAs, STA Control subfield, is updated to include a subfield indicating mesh parameters in Mesh Capable STA Info field, and a subfield indicating mesh parameters in a Mesh Capable STA Profile field.

According to an implementation of the device of the second aspect, the device may further comprise: in case the value of the Mesh Capable Common subfield is equal to 0, the value of Mesh Capable STA Info subfield is set to 1, indicating that the link is mesh capable and all of the mesh configuration information specific to the link is included in the STA Info subfield of the updated MLE.

According to an implementation of the device of the second aspect, the device may further comprise: in case only some of the links of the MLD are mesh capable, a subfield of the updated MLE indicating STA information, STA Info subfield, includes a TBTT Adjusting subfield and/or a Mesh Power Save Level subfield.

According to an implementation of the device of the second aspect, the device may further comprise: the TBTT Adjusting subfield and/or the Mesh Power Save Level subfield are removed from the Mesh Configuration Element of the Common field.

According to an implementation of the device of the second aspect, the device may further comprise: in case a mesh profile of each STA affiliated with the respective mesh STA is the same, the device further being configured to: advertise the mesh capability of the MLD having mesh capability by updating a predefined Mesh Configuration Element.

According to an implementation of the device of the second aspect, the device may further comprise: the predefined Mesh Configuration Element is updated by including a subfield for mesh capability extension, Mesh Capability Extension subfield, and the Mesh Configuration Element includes a subfield indicating mesh capability, Mesh Capability subfield, wherein the last bit of the Mesh Capability subfield indicates whether the Mesh Configuration Element is updated by the Mesh Capability Extension subfield.

The present disclosure further provides a third aspect of a mesh multi-link device, MLD, the MLD being configured to: operate in a mesh network using multi-link operation, MLO, the mesh network including a plurality of mesh STAs and mesh MLDs, communicate over multiple WLAN radio links between one or more AP MLDs and one or more non-AP MLDs, wherein each MLD has one or more affiliated STAs, where each affiliated STA is configured to operate on a different link designated for mesh operation; transmit multi-link operation mesh basic service set, MLO MBSS, information indicating MLO MBSS capability and/or operational parameters; wherein a specific mesh multi-link element, MLE, is included in the MLO MBSS information.

According to an implementation of the device of the third aspect, the device may further comprise: the MLD being configured to transmit multi-link operation mesh basic service set, MLO MBSS, information indicating MLO MBSS capability further comprises the MLD being configured to: transmit a beacon frame or unsolicited Probe Response frame; or transmit a Probe Response frame as a response to a solicited Probe Request frame; or transmit a multi-link Probe Response as a response to a solicited multi-link Probe Request.

According to an implementation of the device of the third aspect, the device may further comprise: the MLD being configured to: update a reduced neighbor report, RNR, element and advertise the updated RNR element in a Beacon frame and Probe Response frame together with the specific MLE; and update mesh operation on one or more STAs affiliated with the MLD allowing the MLD to advertise and discover various MBSSes on the links designated for mesh operation.

According to an implementation of the device of the third aspect, the device may further comprise: the MLD being further configured to: configure the specific MLE for advertising mesh capability, wherein configuring the specific MLE comprises the MLD being configured to: extend a field of the MLE indicating information common to all links, Common Info field, by an element for advertising mesh services, Mesh Configuration Element; update a field of the MLE indicating control of multi-link, Multi-Link Control field, by extending a subfield of the Multi-Link Control field having a bitmap, Presence Bitmap subfield, by an indicator, Mesh Configuration Element Present indicator, indicating that the Mesh Configuration Element is present in the Common Info field, and further extending the Presence Bitmap subfield by an indicator indicating whether all of the links have mesh capability.

According to an implementation of the device of the third aspect, the device may further comprise: the MLD being further adapted to: configure the specific MLE for advertising mesh capability, wherein configuring the specific MLE comprises: in a subfield of the MLE indicating control of multi-link, Multi-Link Control subfield, assigning a new type value in a subfield of the Multi-Link Control subfield, Type subfield, the new type value indicating that the specific MLE is used for mesh operation.

According to an implementation of the device of the third aspect, the device may further comprise:

the MLD being configured to update the RNR element by including a subfield, Mesh Capable subfield, indicating links being available for mesh operation, wherein the value of the Mesh Capable subfield being equal to 1 indicates the link is available for mesh operation.

According to an implementation of the device of the third aspect, the device may further comprise: the MLD being further configured to: discover mesh MLO using a mesh multi-link probe request and response, wherein the discovering comprises: receiving information details of the peer mesh MLD prior to peering with another mesh MLD, wherein the information details received from the mesh MLD include the specific MLE having mesh capability, the specific MLE including a field for link information, Link Info field, about all other affiliated STAs operating in the Mesh BSS or about the specific requested affiliated STAs operating in the Mesh BSS.

According to an implementation of the device of the third aspect, the device may further comprise: the Link Info field indicates which links support the mesh operation and the corresponding mesh parameters.

According to an implementation of the device of the third aspect, the device may further comprise: the mesh multi-link probe request includes the Link Info field indicating the specific one or more affiliated STAs from which a response is required.

According to an implementation of the device of the third aspect, the device may further comprise: in case all links of the MLD are mesh capable, the Common Info field of the updated MLE is used to include the Mesh Configuration Element and indicating that all links support the mesh operation, wherein mesh information included in the Mesh Configuration Element applies to all links; else in case only some of the links of the MLD are mesh capable, information common to all mesh capable links of the MLD is included in the Common Info field of the MLD, whereas link specific information is included in a subfield of the Link Info field of the MLE indicating STA profiles, Per-STA Profile sub element, wherein the link specific information is obtained by receiving a response to a mesh multi-link probe request from a peer MLD having mesh capability.

According to an implementation of the device of the third aspect, the device may further comprise: in case only some of the links of the MLD are mesh capable, a subfield of the Per-STA Profile sub element, indicating control of STAs, STA Control subfield, is updated to include a subfield indicating mesh parameters in a Mesh Capable STA Info field, and a subfield indicating mesh parameters in a Mesh Capable STA Profile field.

According to an implementation of the device of the third aspect, the device may further comprise: in case the value of the Mesh Capable Common field is equal to 0, the Mesh Capable STA Info subfield is set to 1, indicating that the link is mesh capable and all of the mesh configuration information specific to the link is included in the STA Info subfield of the updated MLE.

According to an implementation of the device of the third aspect, the device may further comprise: in case only some of the links of the MLD are mesh capable, a subfield of the updated MLE indicating STA information, STA Info subfield, that includes a TBTT Adjusting subfield and/or a Mesh Power Save Level subfield.

According to an implementation of the device of the third aspect, the device may further comprise: the TBTT Adjusting subfield and/or the Mesh Power Save Level subfield are removed from the Mesh Configuration Element of the Common field.

According to an implementation of the device of the third aspect, the device may further comprise: in case a mesh profile of each STA affiliated with the respective mesh STA is the same, the device further being configured to: advertise the mesh capability of the MLD having mesh capability by updating a predefined Mesh Configuration Element.

According to an implementation of the device of the third aspect, the device may further comprise: the predefined Mesh Configuration Element is updated by including a subfield for mesh capability extension, Mesh Capability Extension subfield, and the Mesh Configuration Element includes a subfield indicating mesh capability, Mesh Capability subfield, wherein the last bit of the Mesh Capability subfield indicates whether the Mesh Configuration Element is updated by the Mesh Capability Extension subfield.

The present disclosure further provides a fourth aspect of a computer program product comprising program code for performing the method according to the first aspect when executed on a computer or a processor.

The present disclosure further provides a fifth aspect of a non-transitory computer-readable medium carrying a program code which, when executed by a computer device, causes the computer device to perform the method according to the first aspect.

### BRIEF DESCRIPTION OF THE DRAWINGS

In the following, embodiments of the invention are described in more detail with reference to the attached figures and drawings, in which:

FIG. 1: illustrates schematically MBSS Discovery

FIG. 2: illustrates schematically an example of MBSS Operation

FIG. 3: illustrates a known Mesh Architecture

FIG. 4: illustrates Multi-Link Devices

FIG. 5: illustrates an MLD Mesh Architecture according to the present disclosure

FIG. 6: illustrates a Multi-Link Element format

FIG. 7: illustrates a Multi-Link Control field format of the MLE of FIG. 6

FIG. 8: illustrates a Per-STA Profile sub-element format of the Basic MLE format of FIG. 6

FIG. 9: illustrates a Mesh Configuration Element format

FIG. 10: illustrates a Mesh Capability field format

FIG. 11: illustrates an updated Presence Bitmap subfield format of the Multi-Link Control field, according to an embodiment of the present disclosure.

FIG. 12: illustrates an updated Common Info field format of the MLE according to a further embodiment of the present disclosure.

FIG. 13: illustrates an updated MLD Parameters subfield format of RNR element according to an embodiment of the present disclosure.

FIG. 14: illustrates a passive scanning and active scanning of MBSS using the Basic MLE according to an embodiment of the present disclosure.

FIG. 15: illustrates passive scanning and active scanning of MBSS using Mesh MLE according to a further embodiment of the present disclosure.

FIG. 16: illustrates a Mesh Multi-Link Probe for mesh MLO discovery using Mesh MLE according to a further embodiment of the present disclosure.

FIG. 17: illustrates a STA Control field format of the updated Basic MLE/Mesh MLE according to a further embodiment of the present disclosure.

FIG. 18: illustrates a STA Info field format of the updated Basic MLE/Mesh MLE according to an embodiment of the present disclosure.

FIG. 19: illustrates a Mesh Capability subfield format within the Mesh Configuration Element according to a further embodiment of the present disclosure.

FIG. 20: illustrates a Mesh Capability Extension subfield format according to an embodiment of the present disclosure.

FIG. 21: illustrates using an extended Mesh Configuration Element to advertise MLO MBSS capability according to an embodiment of the present disclosure.

### DESCRIPTION

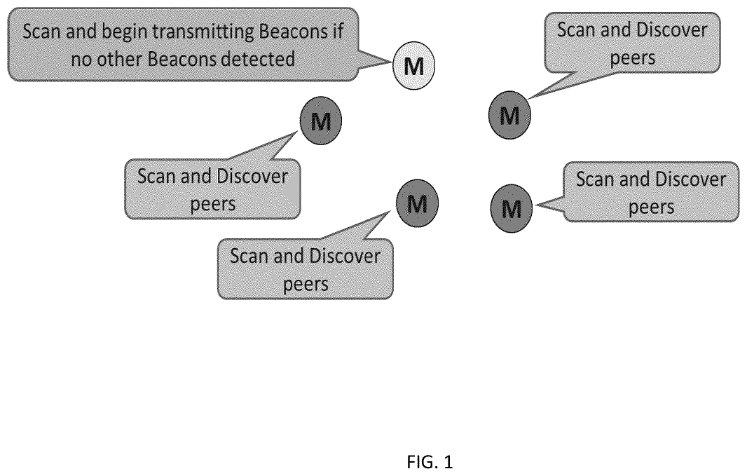

FIG. 1 illustrates several mesh STAs scanning and discovering peers. In this example, when a mesh STA (i.e. a non-AP STA not supporting the functionalities of an Infrastructure BSS), initiates connectivity for a mesh basic service set, MBSS, in other words a mesh network, it attempts to discover other mesh STAs in its proximity and it begins transmitting beacon frames advertising the MBSS. Other mesh STAs then use traditional discovery mechanisms in IEEE 802.11, such as: i) a passive scan, i.e. listening for Beacon or unsolicited Probe Response frames; ii) an active scan, i.e. transmitting a Probe Request and/or receiving a Probe Response.

In FIG. 1, a “mesh profile” identifies the MBSS and is included in Beacon and Probe Response frames. The mesh profile includes a “Mesh ID”, e.g. an Information Element in management frames, which identifies an instance of an MBSS.

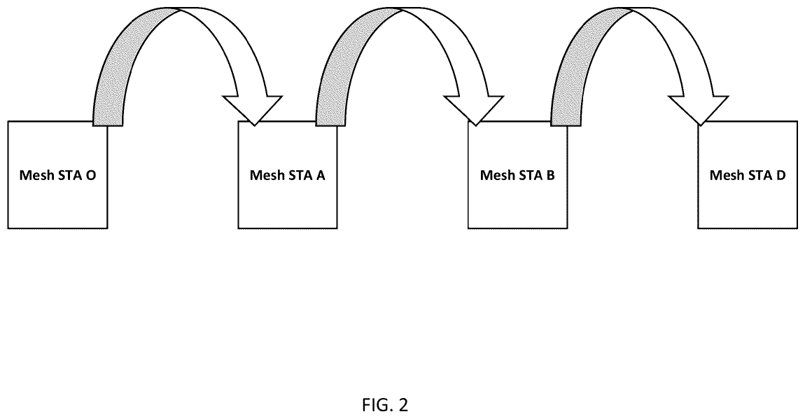

IEEE 802.11 defines communications requirements for STAs that operate in a mesh network. Mesh STAs discover and peer with each other to form mesh links. Data can be routed between peer mesh STAs through a series of hops through other STAs operating in a mesh network. For example, as illustrated for explanatory purposes in FIG. 2, STA O, STA A, STA B, and STA D are peers in a mesh network. These STAs may also be designated as Mesh STAs. In FIG. 2, a frame originating at STA O to a destination, STA D, will be relayed through STA A and STA B.

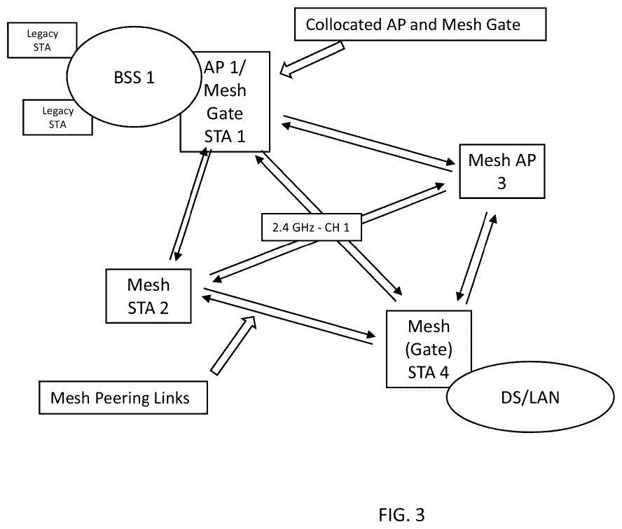

For explanatory purposes, FIG. 3 illustrates a typical Mesh Architecture that may be implemented by IEEE 802.11. Mesh Gates shown in FIG. 3 allow for exchanging of information between the mesh and external infrastructure, e.g. a BSS 1 at STA 1, or a LAN at STA 4. Here, in FIG. 3, mesh peering links are associated links, e.g. with established security between the Mesh STAs. These links are typically within the same WLAN frequency band, e.g. 2.4 GHz.

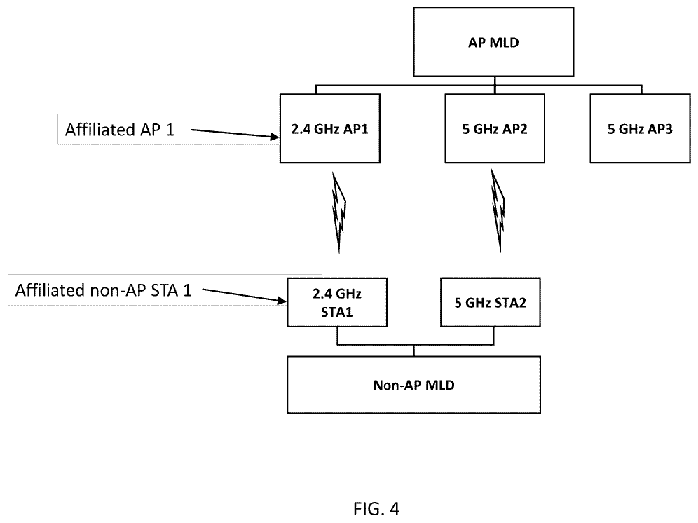

IEEE 802.11be has introduced a multi-link device, MLD. An MLD is shown for explanatory purposes in FIG. 4. MLDs communicate over multiple WLAN radio links between an AP MLD and non-AP MLD. This communication allows for traffic exchange on multiple links and it provides a performance gain of using multiple channels.

In explanatory FIG. 4, each AP MLD has one or more affiliated APs, where each affiliated AP is operating on a different link. Similarly, each non-AP MLD has one or more affiliated non-AP STAs, where each affiliated non-AP STA is operating on a different link. In the example shown in FIG. 4, the AP MLD has three different links. The non-AP MLD has been associated with the AP MLD by setting up two links with the AP MLD, on which the frames exchanged between the AP MLD and the specific non-AP MLD can be transmitted.

IEEE 802.11be also introduces dynamic link transitions, where traffic can be moved from one link to another, as the non-AP STA affiliated with the non-AP MLD, operating on one of the links, can be in active mode or in power save mode.

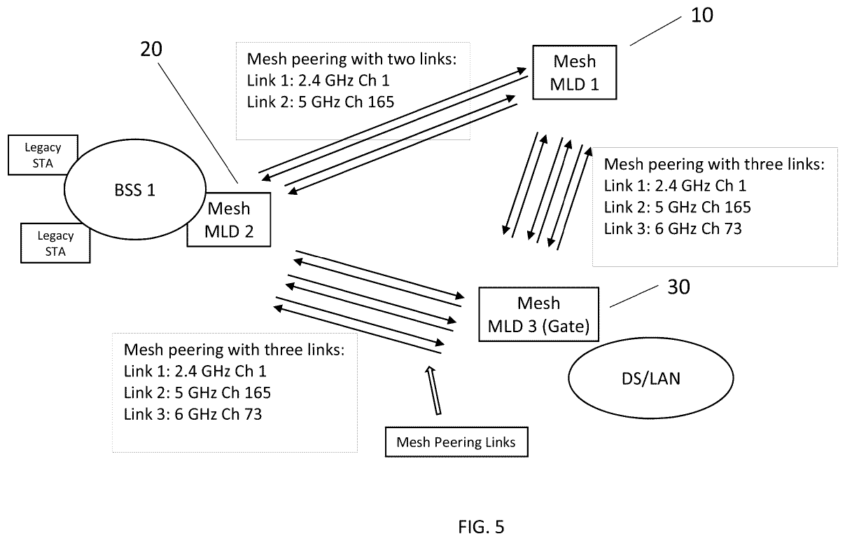

FIG. 5 relates to a combination of the concept for MLD as outlined above together with a mesh architecture, according to the present disclosure. The primary difference between the architecture show in FIG. 5 and the mesh architecture shown in FIG. 3 is that the Mesh MLDs in FIG. 5 are able to exchange information using multiple links in multiple WLAN bands simultaneously. FIG. 5 illustrates three Mesh MLDs, 10, 20, and 30. The number of Mesh MLDs being (only) three is just selected for explanatory purposes. The architecture may include a different number of Mesh MLDs of the Mesh architecture. FIG. 5 illustrates Mesh peering between Mesh MLDs of the Mesh architecture, e.g. Mesh MLDs 10 and 20, using two links: Link 1: 2.4 GHz Ch(annel) 1, Link 2: 5 GHz Ch 165. FIG. 5 further illustrates Mesh peering with three links between Mesh MLDs 10 and 30: Link 1: 2.4 GHz Ch 1, Link 2: 5 GHz Ch 165, and Link 3: 6 GHz Ch 73. FIG. 5 further illustrates Mesh peering with three links between Mesh MLDs 20 and 30: Link 1: 2.4 GHz Ch 1 Link 2: 5 GHz Ch 165.

Furthermore, an IEEE 802.11 RNR element is included in Beacon and Probe Response frames and is defined to include channel and other information about neighbor APs or APs affiliated with the same AP MLD as the AP that transmits the Beacon and Probe Response frames. This may also be referred to as a “reporting AP”.

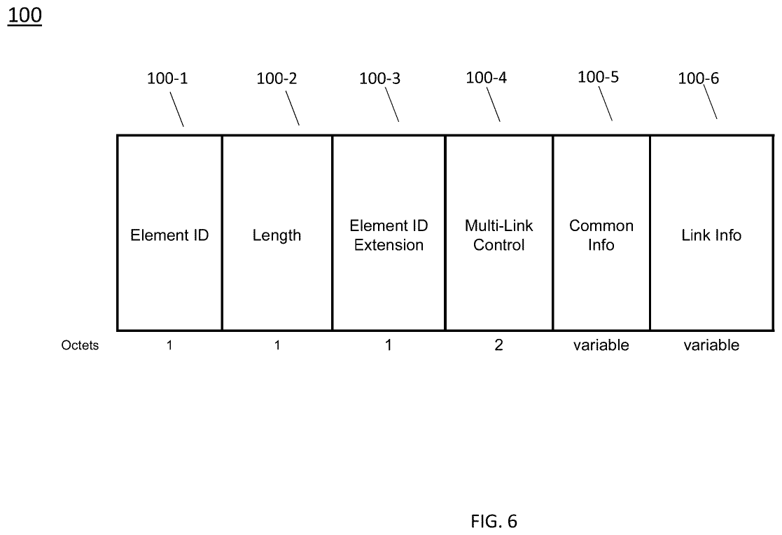

With regard to FIG. 6, a Multi-Link Element is introduced. The Multi-Link Element, MLE, 100 includes information corresponding to other links of the MLD, cf. FIG. 5, that the AP or non-AP STA, transmitting the frame in which the MLE is included, are affiliated with. The format of the MLE 100 is shown in FIG. 6 for explanatory purposes. Thus, FIG. 6 illustrates the format of an MLE. The MLE 100, e.g. as illustrated in FIG. 6, is included mainly in Beacon, Probe Response, Authentication, Association Request and Association Response frames when exchanged between MLDs using one of the affiliated APs/non-APs.

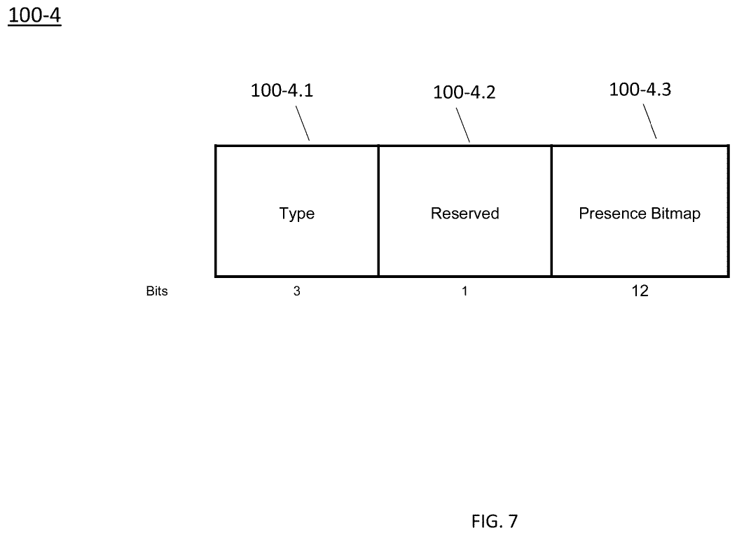

The MLE of FIG. 6 includes an Element ID field 100-1, a Length field 100-2, an Element ID Extension field 100-3, a Multi-Link Control field 100-4, a Common Info field 100-5 and a Link-Info field 100-6. The length/width of these respective fields, measured in octets, is indicated in FIG. 6. Specifically, as shown in FIG. 6, the MLE 100 comprises the Multi-Link Control field 100-4. In FIG. 7, the Multi-Link Control field format 100-4 of FIG. 6 is further illustrated. The Multi-Link Control field 100-4 differentiates the different Type of MLEs, as shown in FIG. 7. FIG. 7 indicates that the Multi-Link Control field 100-4 comprises a Type subfield 100-4.1, a Reserved subfield 100-4.2 and a Present Bitmap subfield 100-4.3. The number of bits included in each of these subfields is indicated in FIG. 7.

The MLE 100 of FIG. 6 further includes a field carrying information to all links, i.e. common information. This field is called a Common Info field 100-5. The Common Info field 100-5, cf. FIG. 6, carries information that is common to all the links, cf. FIG. 5.

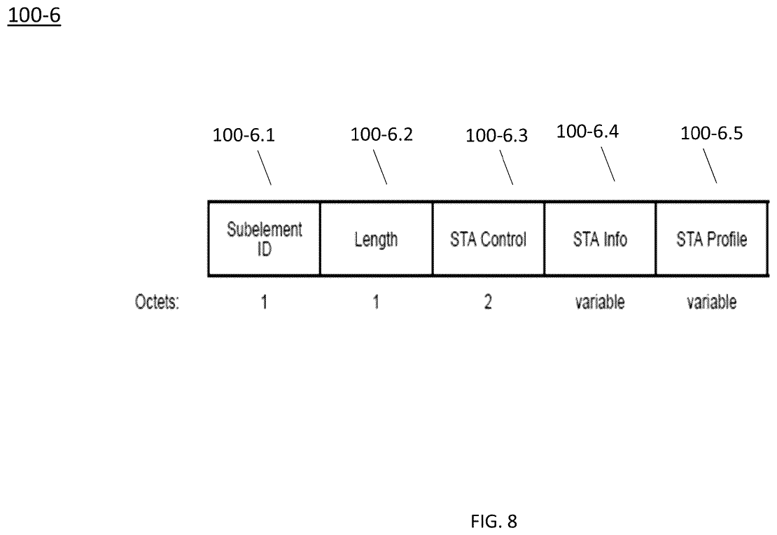

The MLE 100 of FIG. 6 further includes a field carrying specific information for each link. This field is called a Link Info field 100-6, cf. FIG. 6. The Link Info field 100-6 of the MLE 100 carries information specific to each link, cf. STAs of FIG. 4. Each of these information elements is called a Per-STA Profile sub-element. Thus, the Link Info field 100-6 of FIG. 6, comprises sub-elements specific per STA, i.e. Per-STA Profile sub-elements. The Link Info field 100-6 carries one Per-STA Profile sub-element for each affiliated STA, or link, included in the MLD, e.g. the MLDs of FIG. 5. The format of a Per-STA Profile sub-element 100-6.5 of the basic MLE 100 is shown in FIG. 8. FIG. 8 thus illustrates the details of the Link-Info field 100-6. The Per-STA Profile sub-element 100-6 of FIG. 8 includes a Sub-element ID subfield 100-6.1, a Length subfield 100-6.2, a STA Control subfield 100-6.3, an STA Info subfield 100-6.4 and the aforementioned STA Profile subfield 100-6.5. The length/width of the subfields of the Link-Info subfield 100-6, measured in octets, is given in FIG. 8.

It should be noted that during the process of MLD discovery, the Link Info field 100-6 is not included within the basic MLE 100-6 carried in the Beacon and Probe Response frames, as described in the IEEE 802.11be amendment.

Furthermore, an access point, AP, may transmit a multi-link Probe Response, wherein the AP is affiliated with an AP multi-link device, MLD. The Probe Response frame is transmitted in response to a multi-link probe request and carries an MLE to provide a complete or partial profile of one or more APs affiliated with a specific AP MLD as defined in the IEEE 802.11be amendment.

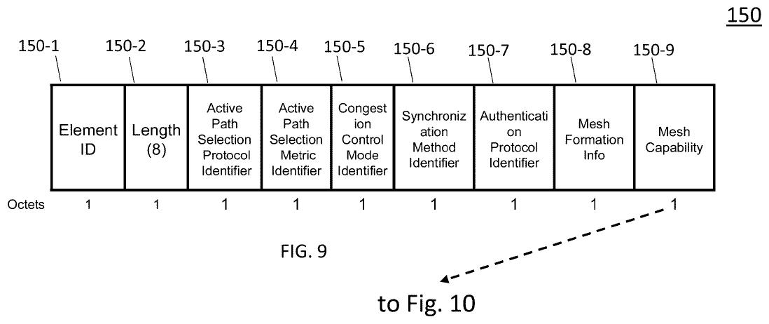

A further element, a Mesh Configuration Element 150 is used to advertise mesh services. The Mesh Configuration Element 150 is transmitted within Beacon and Probe Response frames by mesh STAs. This is illustrated in FIG. 9.

The Mesh Configuration Element 150 shown in FIG. 9 includes an Element ID 150-1, a Length field 150-2, a field indicating an Active Path Selection Protocol Identifier 150-3, a field indicating an Active Path Selection Metric Identifier 150-4, a field indicated a Congestion Control Mode Identifier 150-5, a field indicating a Synchronization Method Identifier 150-6, a field indicating an Authentication Protocol Identifier 150-7, a Mesh Formation Info field 150-8, and a Mesh Capability 150-9. The length/width of these respective field, measured in octets, is indicated in FIG. 9. Here, each subfield of the Mesh Configuration Element identifies various protocols and methods, which control the operation of the mesh.

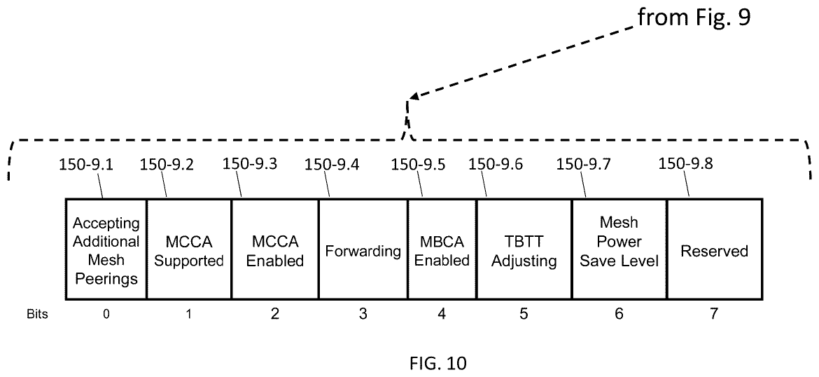

Specifically, the Mesh Configuration Element 150 includes a Mesh Capability field 150-9. The format of the Mesh Capability field 150-9 of the Mesh Configuration Element 150, cf. FIG. 9, is further illustrated in FIG. 10. Each subfield within FIG. 10 may advertise the mesh capability of the mesh STA, cf. FIGS. 4 and 5.

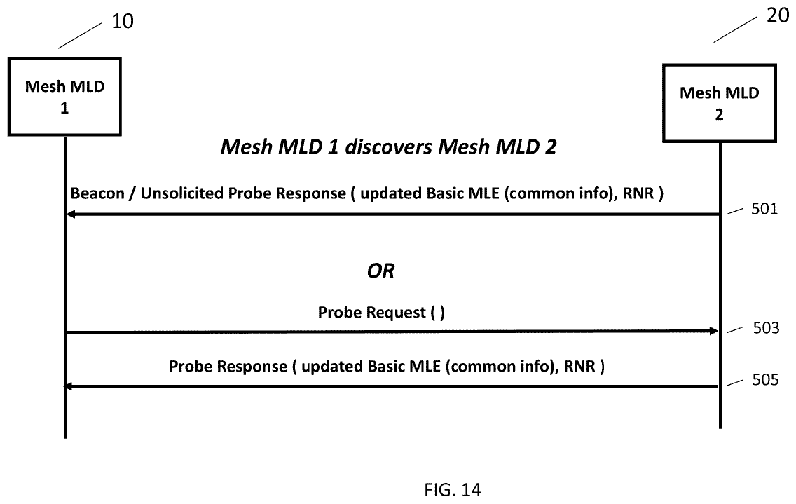

According to a first embodiment of the present disclosure, it is disclosed a method of configuring a mesh multi-link device, MLD, cf. FIG. 5. This method is further illustrated in FIG. 14. Here, the MLD operates in a mesh network using multi-link operation, MLO. The mesh network includes a plurality of mesh STAs and mesh MLDs, the MLD communicates over multiple WLAN radio links between one or more AP MLDs and one or more non-AP MLDs. Each MLD has one or more affiliated STAs, each affiliated STA operates on a different link designated for mesh operation. The steps of the method, as shown in FIG. 14 include a step of receiving multi-link operation mesh basic service set, MLO MBSS, information indicating MLO MBSS capability and/or operational parameters, wherein a specific mesh multi-link element, MLE, is included in the MLO MBSS information and advertising the mesh capability of the MLD using the specific MLE. The RNR element includes the basic information of Neighbor APs to include APs affiliated with the AP MLD as the reporting AP. Specifically, it includes an indication whether the affiliated AP support the MBSS MLO operation.

For the method as illustrated in FIG. 14, the steps of receiving multi-link operation mesh basic service set, MLO MBSS, information indicating MLO MBSS capability may comprise: a step 501 of receiving a beacon frame or unsolicited Probe Response frame; or a step 503 of transmitting a Probe Request frame and a step 505 of receiving a Probe Response frame as a response to a solicited Probe Request frame. In other words, an MLD that wishes to discover an MLO MBSS may: receive a Beacon frame or unsolicited Probe Response frame advertising the capability in updated Basic MLE and RNR element; or may send a Probe Request frame to a prospective AP affiliated with a peer mesh MLD or a broadcast Probe Request frame, waiting for a Probe Response frame indicating MLO MBSS capability in updated Basic MLE and RNR element.

Thus, a modified or even new Mesh MLE may be added to each of the above options, (i.e. carried in Beacon or unsolicited Probe Response frames or carried in Probe Response frame that is transmitted as a response to solicited Probe Request frame or carried in mesh multi-link probe response and mesh multi-link probe response) to advertise the mesh capability, as explained in the further embodiments below. Furthermore, it should be noted that when an MLD receives a frame that includes MLO MBSS capability, it then may authenticate peers with the peer mesh MLD device.

Thus, the first embodiment illustrates a protocol of how an MLD discovers a peer mesh MLD.

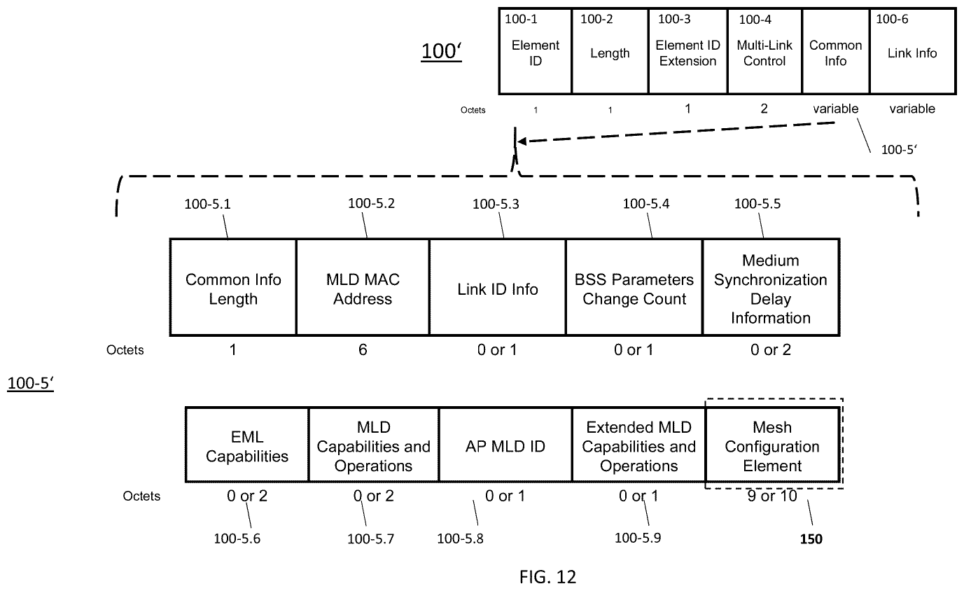

According to a further embodiment of the present disclosure, the MLE 100, as is illustrated in FIG. 6, may be updated to allow advertising and discovery of an MLO MBSS. Thereby, an updated MLE 100′ is achieved as indicated in FIG. 12. For the updated MLE 100′ of FIG. 12, the Mesh Configuration Element 150, as illustrated in FIG. 9, may be added as an extension to the Common Info field of the basic MLE 100. Thus, the Common Info field 100-5 of the basic MLE 100 is updated to become Common Info field 100-5′. This is illustrated in FIG. 12. FIG. 12 illustrates the updated MLE 100-5′ according to the present embodiment. As is shown in FIG. 12, the presence of this extra subfield, namely the Mesh Configuration Element 150 of FIG. 9 indicates that the updated MLE 100′ advertises mesh capability.

The updated MLE 100′ of FIG. 12 includes the same subfields 100-1, 100-2, 100-3, 100-4 and 100-6 as described in the format of the MLE 100 of FIG. 6. These subfields are not repeated here, again. Furthermore, the subfield 100-5 is updated. The updated subfield 100-5′ of the MLE 100′ includes the following subfields: a Common Info Length subfield 100-5.1, an MLD MAC Address subfield 100-5.2, a Link ID Info subfield 100-5.3, a subfield indicating a BSS Parameters Change Count 100-5.3, a Medium Synchronization Delay Information subfield 100-5.5, an EML Capabilities subfield 100-5.6, an MLD Capabilities and Operations subfield 100-5.7, an AP MLD ID subfield 100-5.8, an Extended MLD Capabilities and Operations subfield 100-5.9 and the Mesh Configuration Element 150. The length/width of these respective subfields, measured in octets, is given in FIG. 12.

Within the present embodiment, each STA affiliated with a mesh MLD, cf. FIGS. 4 and 5, may advertise the updated MLE 100′ in Beacon and Probe Response frames it transmits. As mentioned above, when the updated MLE 100′ is used in a discovery mode, e.g. in order to advertise information about an MLD, the Link Info field 100-6 of the MLE 100 or 100′ is not included in the respective MLE. Therefore, to transmit concise information about the available MLD links suitable for mesh operation, an RNR element needs to be included in the Beacon or Probe Response frames. The RNR element allows the peer mesh MLD to determine the available links and information about affiliated STAs for the mesh peering and operation. The RNR element is updated to indicate the links that suitable for a mesh operation. Further, for the present embodiment, a mesh enabled STA, e.g. a STA, that transmits a Beacon frame and/or Probe Response frames, which include the updated MLE 100′, must be affiliated with a Mesh MLD.

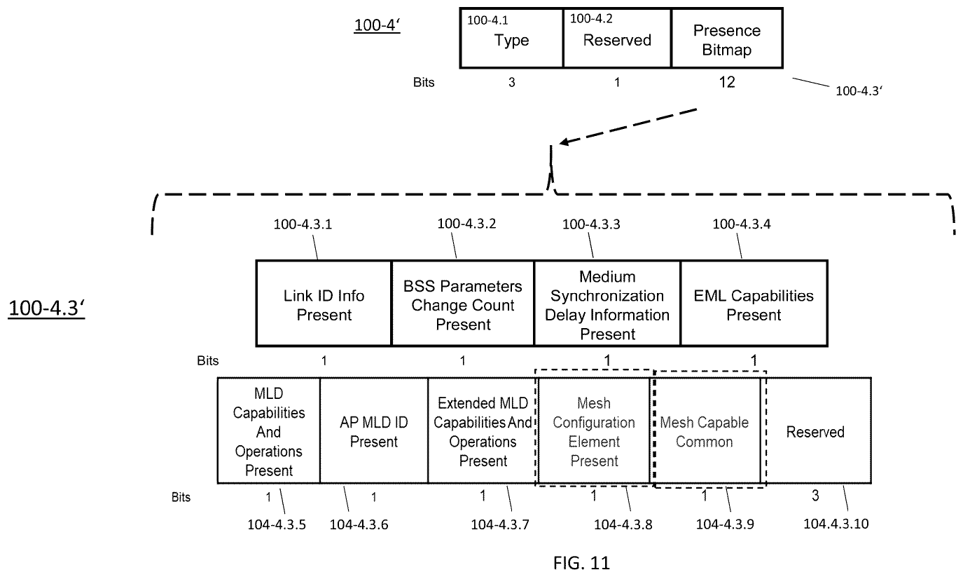

As indicated in FIG. 7, the Multi-Link Control field 100-4 of the basic MLE 100 of FIG. 6 includes a Presence Bitmap subfield 100.4.3. The Presence Bitmap subfield 100.4.3 of the Multi-Link Control field 100-4 also needs to be updated and becomes an updated Presence Bitmap subfield 100-4′. Updating the Presence Bitmap subfield 100-4.3 to become an updated Presence Bitmap subfield 100-4′ has the purpose to indicate that a Mesh Configuration Element 150 is added to the Common Info field 100-5 of the MLE 100, thereby yielding an updated Common Info field 100-5′ of the updated MLE 100′. As shown in FIG. 11, the updated Presence Bitmap 100-4.3′ subfield of the updated Multi-Link Control field 100-4′ includes a Mesh Configuration Element Present indicator subfield 104-4.3.8. This indicator 104-4.3.8 includes a new subfield “Mesh Configuration Element Present”. When this subfield is set to 1, the indicator 104-4.3.8 indicates that the updated MLE 100′ includes a Mesh Configuration Element 150, cf. FIGS. 11 and 12. The other bits of the Presence bitmap subfield 100-4.3′ are defined in the IEEE 802.11be amendment.

A further new subfield “Mesh Capable Common” is also included in the updated Presence bitmap subfield 100-4.3′, cf. FIG. 11. When this subfield, i.e. “Mesh Capable Common” is set to 1, it indicates that all of the links of this MLD are mesh capable. In this case, all of the mesh configuration information required for each of those mesh capable links is included in the Common Info field 100-5′ of the updated MLE 100′. If the “Mesh Capable Common” bit of the updated Presence bitmap subfield 100-4.3′, cf. FIG. 11, is set to 0, it indicates that not all the links of this MLD support mesh operation.

Summarizing, FIG. 12, illustrates that the Common Info field 100-5 of the MLE 100, cf. FIG. 6, is updated with the Mesh Configuration Element 150, to become the updated Common Info field 100-5′ and updated MLE 100′. The Common Info field of other MLEs may be updated in a similar manner.

The remainder elements of the Common Info field 100-5 and 100-5′ are described in the IEEE 802.11be amendment. Some of the information within the Mesh Configuration Element 150 may not be common to all the links within an MLD. This is further considered within Embodiment 5.

Furthermore, in FIG. 12, the position of the Mesh Configuration element 150, namely at the end of the updated Common Info field 100-5′ is merely shown as an example and the Mesh Configuration Element 150 may be placed elsewhere within the updated Common Info field 100-5′. Note that the length of the Mesh Configuration Element 150 is either 9 octets or 10 octets, e.g. the length as updated by Embodiment 6.

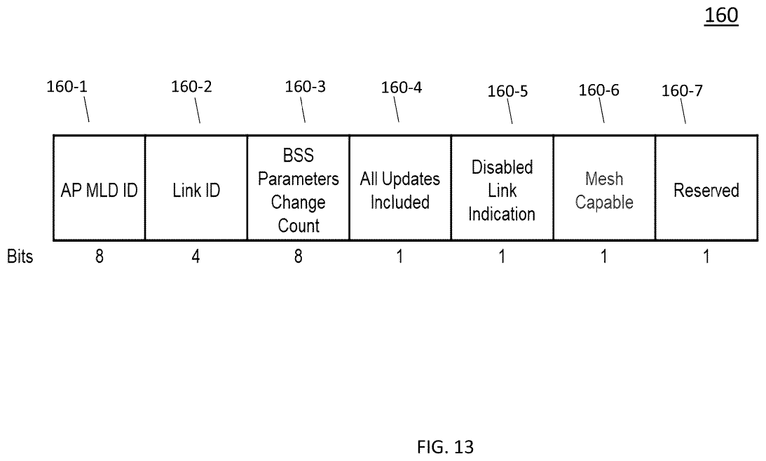

With regard to the RNR element, the RNR element includes a reduced set of parameters for each of the other APs that are affiliated with the AP MLD as the reporting AP. FIG. 13 illustrates that to indicate those links that are available for mesh operation, one of the two bits is used within the Reserved subfield 160 of the MLD Parameters subfield within the RNR.

FIG. 13 illustrates that the RNR MLD Parameters Subfield 160 comprises an AP MLD ID subfield 160-1, a Link ID subfield 160-2, a BSS Parameters Change Count subfield 160-3, an “All Updates Included” subfield 160-4, a “Disabled Link Indication” subfield 160-5, a Mesh Capable subfield 160-6, and a Reserved subfield 160-7.

The Reserved subfield of the RNR MLD Parameters Subfield 60, as shown in FIG. 13, is split, so that the first subfield of it is named “Mesh Capable” and is set to 1 to indicate that the link is available for mesh operation.

An example message flow for the advertisement and discovery of MLO MBSS capability using the updated MLE is shown in FIG. 14. FIG. 14 illustrates a passive scanning and active scanning of MBSS using the Basic MLE according to the first embodiment of the present disclosure.

In FIG. 14, Mesh MLD2, denoted by reference number 20, transmits an updated MLE such as the updated MLE 100′ within a Beacon or unsolicited Probe Response frame to Mesh MLD 1, denoted by reference number 10. The RNR element includes information about each of the STAs affiliated with the mesh MLD STA. Alternatively; if the Mesh MLD2 receives a legacy Probe Request from MLD1, it can take the opportunity add an updated MLE and RNR element in the probe response frame, i.e. in addition to the legacy probe response information.

It should be noted that Multi-Link Operation, MLO, defines a multi-link probe request and multi-link probe response as a Probe Request frame with a Probe Request MLE, and a Probe Response frame, with a basic MLE 100.

The multi-link probe request and response are used by a non-AP MLD to discover the capabilities of a single AP MLD.

Summarizing, embodiment 2 allows a Mesh MLD to advertise its MLO MBSS capability in an updated MLE 100′.

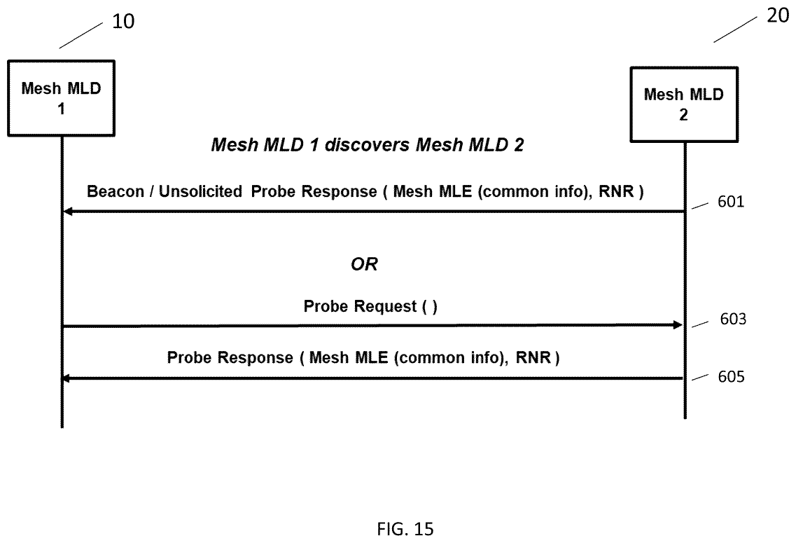

While embodiment 2 relates to updating the MLE 100 to become updated MLE 100′, the present disclosure discloses a further embodiment. The message flow of embodiment 3 is shown in FIG. 15. For embodiment 3, instead of updating the (Basic) MLE 100, i.e. updating the MLE 100 shown in FIG. 6, embodiment 3 relates to defining a new Mesh MLE. In a sense this may be regarded as “completely” updating the MLE 100. FIG. 7 illustrates a Multi-Link Control field. Embodiment 3 uses this Multi-Link Control field 100-4 and introduces and assigns a new “Type” within the Multi-Link Control field 100-4, cf. the Type subfield 100-4.1 of the Multi-Link Control field 100-4 as illustrated in FIG. 7. An example value of “5” may be assigned to this Type value in order to indicate that the new MLE of embodiment 3 is used for mesh operation. It should be noted that the value “5” may be substituted by a different appropriate value. Having defined the new Type, i.e. “5”, for the Type subfield 100-4.1 within the Multi-Link Control field 100-4, the operation and behavior of the Mesh MLE is otherwise identical to the updated MLE 100 described above.

FIG. 15 illustrates an example message flow for the advertisement and discovery of MLO MBSS capability using the Mesh MLE of embodiment 3. FIG. 15 illustrates passive scanning and active scanning of MBSS using a (new) Mesh MLE according to embodiment 3 of the present disclosure.

In FIG. 15, in step 601 Mesh MLD2, element 20, transmits a Mesh MLE within a Beacon or unsolicited Probe Response frame to Mesh MLD1, element 10. The RNR element includes information about each of the STAs affiliated with the mesh MLD STA. Steps 603 and 605 are similar to steps 503 and 505 of FIG. 14, respectively.

Alternatively, if Mesh MLD2 in FIG. 15 receives a legacy Probe Request from a STA affiliated with MLD1, it can take the opportunity to include a Mesh MLE and RNR element in the probe response frame, i.e. in addition to the legacy probe response information.

It should be noted that FIG. 14 and FIG. 15 describe the same sequence of frames but with the following distinction: FIG. 14 includes the option of using an updated/modified Basic MLE to include an indication of MBSS MLO capability and parameters. FIG. 15 includes the option of using a (new) mesh MLE to include indication of MBSS MLO capability and parameters.

Summarizing, embodiment 3 allows a Mesh MLD to advertise its MLO MBSS capability in a new Mesh MLE. Otherwise, embodiment 3 is similar to embodiment 2.

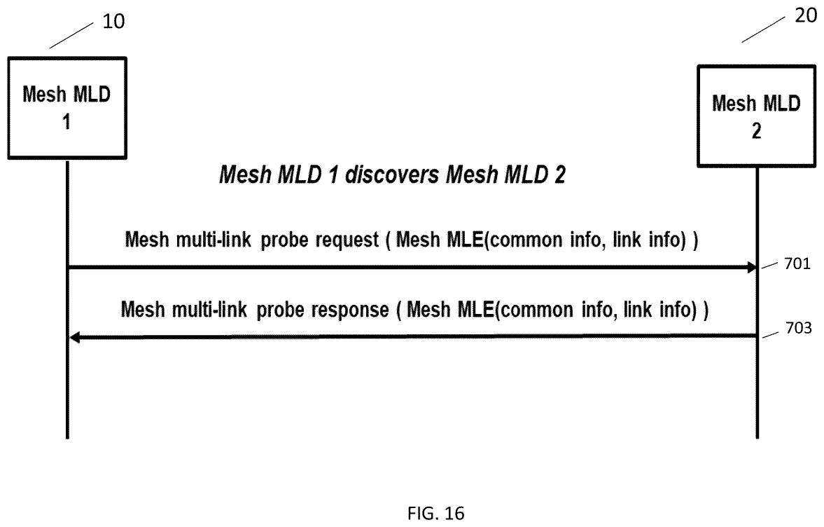

FIG. 16 relates to a further embodiment of the present disclosure. According to embodiment 4 a mesh MLD may use a mesh multi-link, ML, probe request transmitted to a peer MLD to receive the full information details of that peer mesh MLD prior to mesh peering. Thus, according to this embodiment, this enables a different way for an MLD to probe a peer MLD for more information. This mesh multi-link probe request is a Probe Request frame that includes a Mesh MLE.

According to this embodiment, the peer mesh MLD will respond with a mesh multi-link probe response that includes the Mesh MLE including the Link Info subfield for the full link information (i.e. the full link information applies to mesh parameters of those links) on all other affiliated STAs that are operating in the Mesh BSS or the specific requested affiliated STAs that are operating in the Mesh BSS. Furthermore, according to this embodiment, the Link Info subfield indicates which links are available to negotiate in mesh peering. Furthermore, the Mesh multi-link probe request can include a Link Info part in order to indicate for each specific affiliated STAs the response that is required. FIG. 16 illustrates an example message flow for this embodiment.

Summarizing, this embodiment allows the use of mesh multi-link probe request and responses to signal MLO MBSS capability within a Mesh MLE.

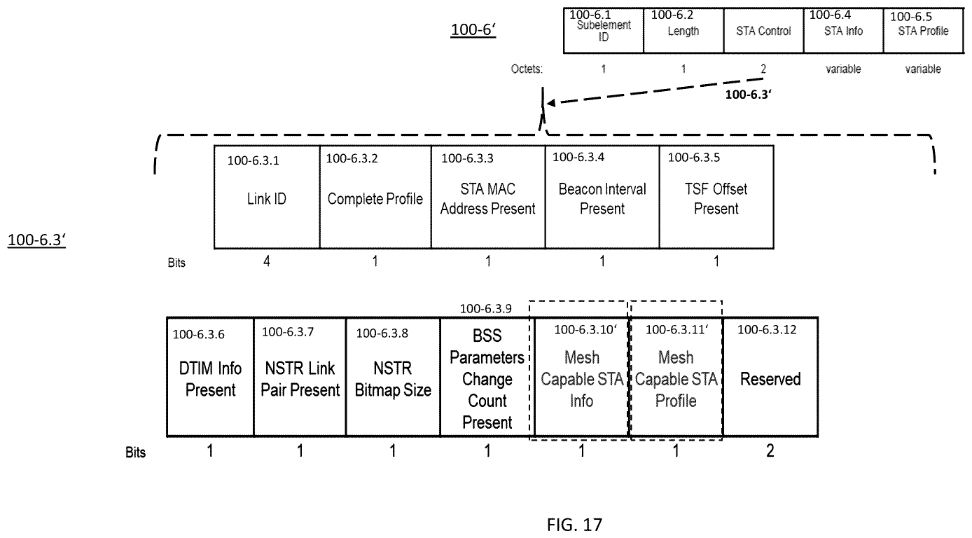

FIG. 17 relates to a further embodiment of the present disclosure. This embodiment relates to that there are situations where all of the links in an MLD are mesh capable and sometimes situations when only a subset of links in an MLD are mesh capable. If all the links are mesh capable, the Common Info field 100-5 of the basic MLE 100, see FIG. 6, of the updated MLE 100′ of the updated MLE 100′ of FIG. 12, or of the new MLE of embodiment 3, may be used to include the Mesh Configuration Element 150, as described with respect to Embodiment 2, see FIG. 12, as well as described with regard to Embodiment 3. The mesh information included in the Mesh Configuration Element 150 then applies to all the links.

On the other hand, in another situation where only some links are mesh capable, the Common Info field 100-5 of the MLE 100 may not be appropriate for all of the information relating to the Mesh Configuration Element 150. In this case, the Mesh Configuration Element 150 needs to be split, such that common information about the mesh remains in the Common Info field, e.g. 100-5 or 100-5′, but the link specific information moves into the Per-STA Profile sub-element 100-6.5 of the Link Info field 100-6 of the MLE 100 as first shown in FIG. 8.

Note that as the Link Info field 100-6 is not transmitted in a Beacon, a mesh multi-link probe request must be used to obtain this information from a peer mesh MLD.

To indicate that mesh configuration information is present within the Per-STA Profile sub-element 100-6.5, the STA Control Field 100-6.3, see FIG. 8 is updated as well, as shown in FIG. 17. Thus, the STA Control field 100-6.3 of FIG. 8 becomes an updated STA Control Field 100-6.3′ of the updated Link Info subfield 100-6′. The new allocated subfields also describe where the link specific information is to be found.

As shown in FIG. 17, the updated STA Control field 100-6.3′ of the updated Link Info subfield 100-6′ comprises: a Link ID subfield 100-6.3.1, a “Complete Profile” subfield 100-6.3.2, a “STA MAC Address Present” subfield 100-6-3.3, a “Beacon Interval Present” subfield 100-6.3.4, a TSF Offset Present subfield 100-6.3.5, a DTIM Info Present subfield 100-6.3.6, an NSTR Link Pair Present subfield 100-6.3.7, an NSTR Bitmap Size subfield 100-6.3.8, a “BSS Parameters Change Count Present” subfield 100.6.3.9, a Mesh Capable STA Info subfield 100-6.3.10′, a Mesh Capable STA Profile subfield 100-6.3.11′, and a Reserved subfield 100-6.3.12.

Thus, as shown in FIG. 17, Reserved bits from the end of the STA Control field 100-6.3′ are used to indicate whether the link is Mesh Capable or not. The Mesh Capable STA Info subfield 100-6-3.10′ and Mesh Capable STA Profile subfield 100-6.3.11′ are mutually exclusive, their value cannot be set to 1 for both subfields (bits) at the same time.

Within this embodiment, if the Mesh Capable Common bit, i.e. the subfield “Mesh Capable Common” of the updated Presence bitmap subfield 100-4.3′, cf. FIG. 11, is equal to 0, the Mesh Capable STA Info bit 100-6-3.10′ when set to 1, indicates that the link is mesh capable and all of the mesh configuration information specific to the link is included in the STA Info field 100-6.4 of the updated Link Info subfield 100-6′.

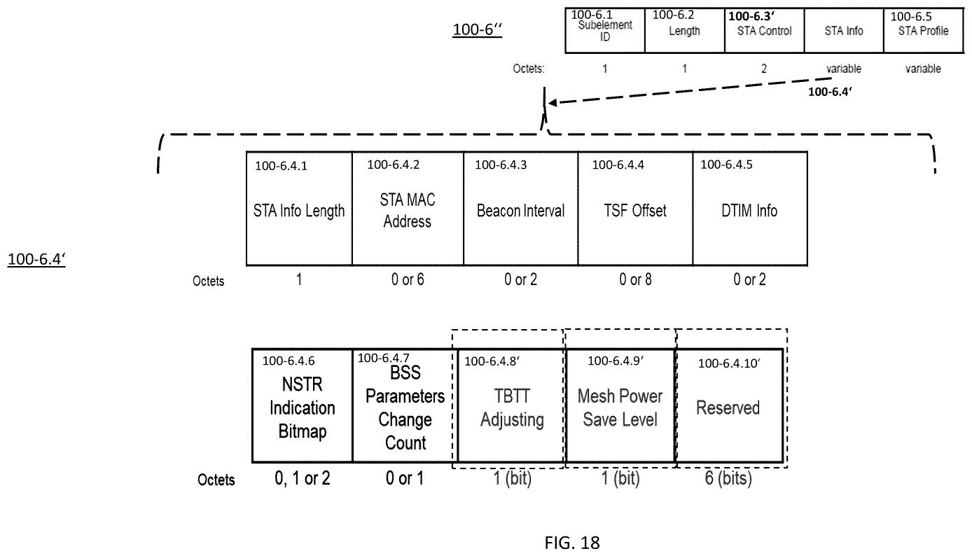

Within this embodiment, an example of the link specific subfields of the Mesh Configuration Element 150 being placed within the STA Info field, i.e. an updated STA Info field 100-6.4′, is shown in FIG. 18. In FIG. 18, the updated STA Info field 100-6.4′ comprises subfields as follows: a STA Info Length subfield 100-6.4.1, a STA MAC address subfield 100-6.4.2, a Beacon Interval subfield 100-6.4.3, a TSF Offset subfield 100-6.4.4, a DTIM Info subfield 100-6.4.5, an NSTR Indication Bitmap subfield 100-6.4.6, a BSS Parameters Change Count Present subfield 100-6.4.7, a TBTT Adjusting subfield 100-6.4.8′, a Mesh Power Save Level subfield 100-6.4.9′, and a Reserved subfield 100-6.4.10′. It should be noted that (sub)fields with the same name in FIG. 17 and FIG. 18 are the same, but derive from either 100-6.3′ or 100-6.4′ and thus are denoted with different reference signs to indicate the difference.

The “TBTT Adjusting” and “Mesh Power Save Level” subfields of the Mesh Configuration Element are thus moved into the STA Info field 100-6.4′ of the updated Link Info subfield 100-6″, as these parameters are link specific. These subfields should be removed from the Mesh Configuration Element 150 within the Common Field 100-5′, see FIG. 12.

Furthermore, if the Mesh Capable Common bit, i.e. the subfield “Mesh Capable Common” of the updated Presence bitmap subfield 100-4.3′, cf. FIG. 11, is equal to 0, the Mesh Capable STA Profile bit 100-6.3.11′ when set to 1, indicates that the link is mesh capable and all of the mesh configuration information specific to the link is included in the STA Profile field.

According to IEEE 802.11be D4.0, the specific format of the STA Profile subfield 100-6.5, as shown in FIGS. 8, 17, and 18 is highly dependent on the context it is used.

In a similar way, when comparing FIG. 10 to FIG. 18, the “TBTT Adjusting” subfield 150-9.6 becomes subfield 100-6.4.8′, the “Mesh Power Save Level” subfield 150-9.7 becomes 100-6.4.9′, i.e. these subfields are moved from the Mesh Configuration Element 150 to the end of the STA Profile field 100-6.5, as these parameters are link specific. In other words, the two subfields “TBTT Adjusting” 100-6.4.8′ and “Mesh Power Save Level” 100-6.4.9′ may be added to the end of either the “STA Info” field 100-6.4′, cf. FIG. 17, or the “STA Profile” field 100-6.5 as shown in FIG. 18.

Thus, embodiment 5 allows the legacy mesh configuration information in the Mesh Configuration Element to be re-mapped within an MLD architecture, providing both common MLD mesh specific information and MLD mesh link specific information.

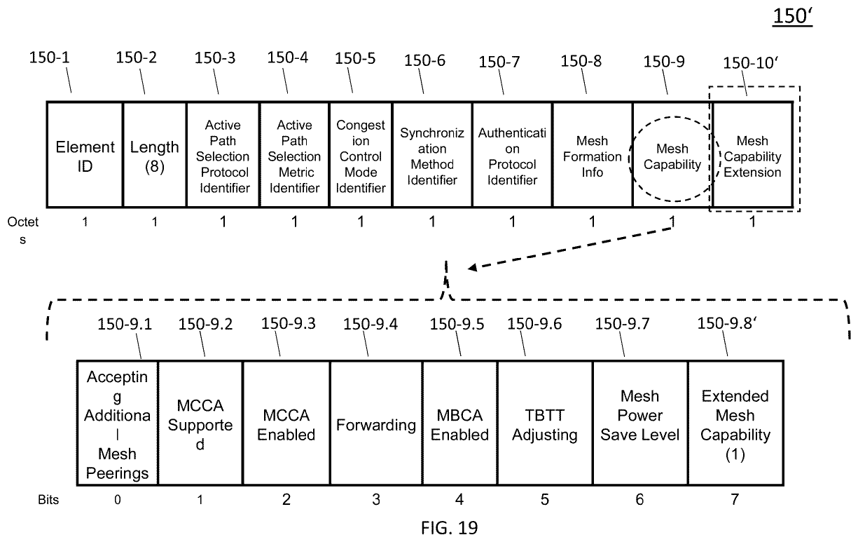

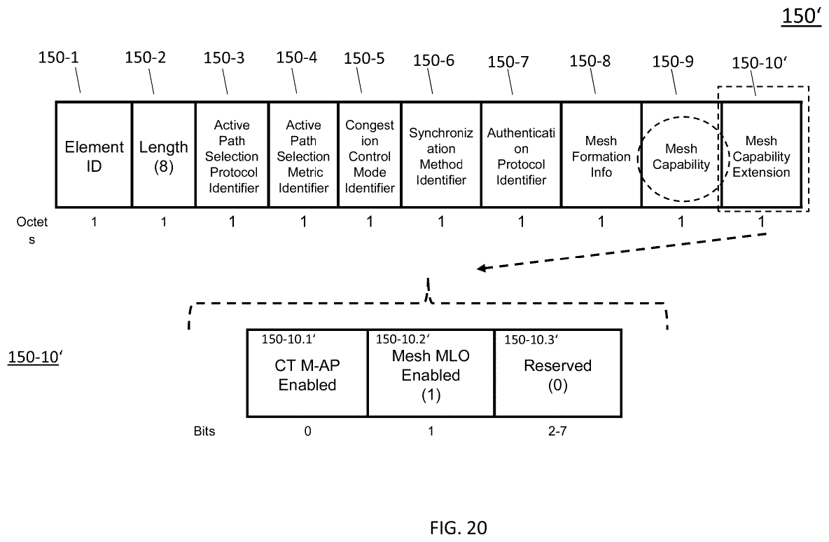

FIGS. 19 and 20 relate to a further embodiment of the present disclosure. According to embodiment 6, it is provided an alternative way to advertise a mesh MLD. According to embodiment 6, a mesh MLD is advertised by updating a known Mesh Configuration Element, e.g. a Mesh Configuration Element according to IEEE 802.11 standard. In other words, advertising a mesh MLD may include re-using the legacy mesh signaling for STAs as shown in FIG. 3, with a minor enhancement. This is possible only if the mesh profile of each STA affiliated with the mesh STA MLD is identical.

An updated Mesh Configuration Element 150′ is shown in FIG. 19.

Elements 150-1, 150-2, . . . 150-9 were already introduced with respect to FIG. 10. This is not repeated here. FIG. 19 indicates that the updated Mesh Configuration Element further includes an element 150-10′ referred to as a Mesh Capability Extension field of the updated Mesh Configuration Element 150′. Here, a reserved subfield is allocated in the Mesh Capability Extension field 150-10′ in order to advertise Mesh MLO capability. The enhanced Mesh Configuration Element 150′ is then transmitted in Beacon and Probe Response frames. Information about the links is then requested using the multi-link probe request and response as described in Embodiment 4.

Furthermore, Bit 7 of the Mesh Capability subfield 150-9 of the Mesh Configuration Element 150′, indicates that there is an extra subfield “Mesh Capability Extension” 150-10′ at the end of the Mesh Configuration Element 150′.

FIG. 20 illustrates the subfields of the Mesh Capability Extension subfield 150-10′. FIG. 20 illustrates that the Mesh Capability Extension subfield 150-10′ comprises a CT M-AP Enable subfield 150-10.1′, a Mesh MLO Enable subfield 150-10.2′, and a Reserved subfield 150-10.3′. This subfield is denoted Mesh MLO Enabled subfield 150-10.2′ as shown in FIG. 20.

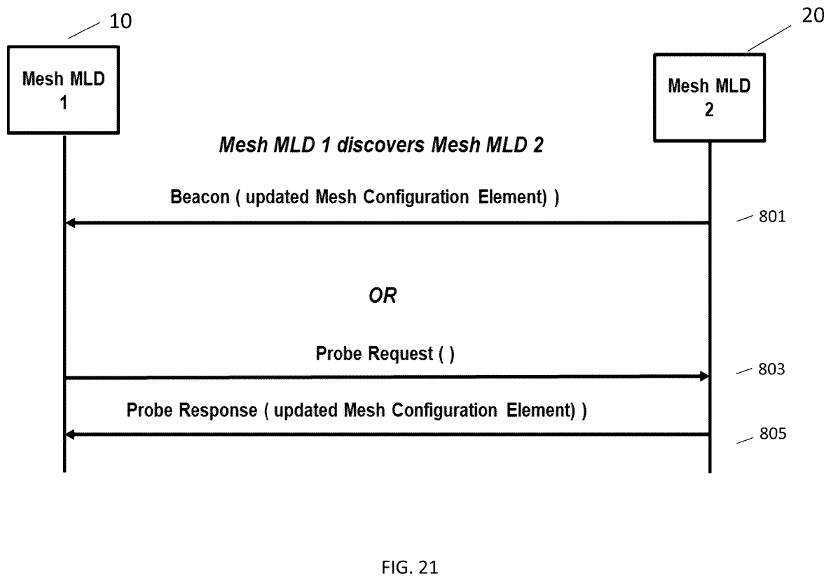

An example message flow is shown in FIG. 21. FIG. 21 illustrates that a Mesh MLD 2, i.e. element 20, transmits a beacon including an updated Mesh Configuration Element 150′, step 801. The beacon frame is a broadcast frame. It is received by all (nearby) recipients, including Mesh MLD-1, element 10, as indicated in FIG. 21. Alternatively, Mesh MLD-1, i.e. element 10, sends a Probe Request frame to Mesh MLD 2, element 20, step 803. Then, the Mesh MLD 2 responds by sending a Probe Response frame including the updated Mesh Configuration Element 150′, step 805.

Thus, embodiment 6 allows a legacy Mesh Configuration Element 150 to be updated to become Mesh Configuration Element 150′, Mesh Configuration Element 150′ being capable to advertise MLO MBSS capability.

### SUMMARY

Summarizing, the key points of the present disclosure are as follows: The present disclosure provides a protocol for how an MLD discovers a peer mesh MLD. The present disclosure provides new subfield definitions to enable a Mesh MLD to advertise its MLO MBSS capability.

Furthermore, the present disclosure adapts prior art IEEE 802.11 mesh STA signaling to enable a mesh MLD to advertise its MLO MBSS capability.

### ABBREVIATIONS

AP Access Point
BSS Basic Service Set
DS/LAN Distributed System/Local Area Network
DTIM Delivery Traffic Indication Map
LAN Local Area Network
MAC Media Access Control
MBSSMesh Basic Service Set
MBCA Mesh Beacon Collision Avoidance
MCF Mesh Coordination Function
MCCA MCF Controlled Channel Access
ML Multi-Link
MLD Multi-Link Device
MLE Multi-Link Element
MLO Multi-Link Operation
MLO MBSS Multi-Link Operation MBSS
NSTR Number of Streams
RNR Reduced Neighbor Report
STA Station
TBTT Target Beacon Transmission Time
TSF Timing Synchronization Function
WLAN Wireless Local Area Network

What is claimed is:

1. A method of configuring a mesh multi-link device (MLD), wherein the MLD operates in a mesh network using multi-link operation (MLO), wherein the mesh network includes a plurality of mesh stations (STAs) and mesh MLDs, wherein the MLD communicates over multiple wireless local area network (WLAN) radio links between one or more access point (AP) MLDs and one or more non-AP MLDs, wherein each of the plurality of MLDs has one or more affiliated STAs, and wherein each affiliated STA operates on a different link designated for mesh operation, the method comprising:
receiving multi-link operation mesh basic service set (MLO MBSS) information indicating MLO MBSS capability and/or operational parameters,
wherein a mesh multi-link element (MLE) is included in the MLO MBSS information; and
advertising a mesh capability of the MLD using the MLE.

2. The method according to claim 1, wherein receiving the MLO MBSS information indicating MLO MBSS capability comprises:
receiving a beacon frame or unsolicited probe response frame; or
receiving a probe response frame as a response to a solicited probe request frame; or
receiving a multi-link probe response as a response to a solicited multi-link probe request.

3. The method according to claim 1, further comprising:
updating a reduced neighbor report (RNR) element and advertising the updated RNR element in a beacon frame and probe response frame together with advertising the MLE; and
updating mesh operation on one or more STAs affiliated with the MLD, allowing the MLD to advertise and discover various MBSSs on the links designated for mesh operation.

4. The method according to claim 1, further comprising discovering mesh MLO using a mesh multi-link probe request and response,
wherein the discovering comprises receiving information of the peer mesh MLD prior to peering with another mesh MLD,
wherein the information received from the mesh MLD includes the MLE having mesh capability, and
wherein the MLE includes a field for link information (link info field) corresponding to all other affiliated STAs operating in the mesh BSS or about specific requested affiliated STAs operating in the mesh BSS.

5. The method according to claim 4, wherein based on all links of the MLD being mesh capable, a common info field of an updated MLE is used to include a mesh configuration element and indicating all links support the mesh operation, wherein mesh information included in the mesh configuration element applies to all links;
wherein based on only some of the links of the MLD being mesh capable, information common to all mesh capable links of the MLD is included in the common info field of the MLD, whereas link specific information is included in a subfield of the link info field of the MLE indicating STA profiles, per-STA profile sub element, and
wherein the link specific information is obtained by receiving a response to a mesh multi-link probe request from a peer MLD having mesh capability.

6. The method according to claim 5, wherein based on only some of the links of the MLD being mesh capable, a subfield of the per-STA profile sub element, indicating control of STAs, STA control subfield, is updated to include a subfield indicating mesh parameters in a mesh capable STA info field, and a subfield indicating mesh parameters in a mesh capable STA profile field.

7. The method according to claim 6, wherein based on the value of the mesh capable common subfield being equal to 0, the value of the mesh capable STA info subfield is equal to 1, indicating the link is mesh capable and all of the mesh configuration information specific to the link is included in the STA info subfield of the updated MLE.

8. A mesh multi-link device (MLD) configured to:
operate in a mesh network using multi-link operation (MLO), wherein the mesh network includes a plurality of mesh stations (STAs) and mesh MLDs,
communicate over multiple wireless local area network (WLAN) radio links between one or more access point (AP) MLDs and one or more non-AP MLDs,
wherein each MLD has one or more affiliated STAs, and
wherein each affiliated STA is configured to operate on a different link designated for mesh operation;
receive multi-link operation mesh basic service set (MLO MBSS) information indicating MLO MBSS capability and/or operational parameters,
wherein a mesh multi-link element (MLE) is included in the MLO MBSS information; and
advertise the mesh capability of the MLD using the MLE.

9. The device according to claim 8, wherein the MLD configured to receive the MLO MBSS information indicating MLO MBSS capability is further configured to:
receive a beacon frame or unsolicited probe response frame; or
receive a probe response frame as a response to a solicited probe request frame; or
receive a multi-link probe response as a response to a solicited multi-link probe request.

10. The device according to claim 8, wherein the MLD is further configured to:
update a reduced neighbor report (RNR) element and advertise the updated RNR element in a beacon frame and probe response frame together with the MLE; and
update mesh operation on one or more STAs affiliated with the MLD allowing the MLD to advertise and discover various MBSSs on the links designated for mesh operation.

11. A mesh multi-link device (MLD) configured to:
operate in a mesh network using multi-link operation (MLO), wherein the mesh network includes a plurality of mesh stations (STAs) and mesh MLDs,
communicate over multiple wireless local area network (WLAN) radio links between one or more access point (AP) MLDs and one or more non-AP MLDs,
wherein each MLD has one or more affiliated STAs, where each affiliated STA is configured to operate on a different link designated for mesh operation; and
transmit multi-link operation mesh basic service set (MLO MBSS) information indicating MLO MBSS capability and/or operational parameters,
wherein a mesh multi-link element (MLE) is included in the MLO MBSS information.

12. The device according to claim 11, wherein the MLD configured to transmit the MLO MBSS information indicating MLO MBSS capability is further configured to:
transmit a beacon frame or unsolicited probe response frame; or
transmit a probe response frame as a response to a solicited probe request frame; or
transmit a multi-link probe response as a response to a solicited multi-link probe request.

13. The device according to claim 11, wherein the MLD is further configured to:
update a reduced neighbor report (RNR) element and advertise the updated RNR element in a beacon frame and probe response frame together with the MLE; and
update mesh operation on one or more STAs affiliated with the MLD allowing the MLD to advertise and discover various MBSSs on the links designated for mesh operation.

14. A computer program product comprising program code for performing a method of configuring a mesh multi-link device (MLD) operating in a mesh network using multi-link operation (MLO), wherein the mesh network includes a plurality of mesh stations (STAs) and mesh MLDs, wherein the MLD communicates over multiple wireless local area network (WLAN) radio links between one or more access point (AP) MLDs and one or more non-AP MLDs, wherein each MLD has one or more affiliated STAs, and wherein each affiliated STA operates on a different link designated for mesh operation, the method comprising:
receiving multi-link operation mesh basic service set (MLO MBSS) information indicating MLO MBSS capability and/or operational parameters,
wherein a mesh multi-link element (MLE) is included in the MLO MBSS information; and
advertising the mesh capability of the MLD using the MLE.
